(19) United States
(12) Patent Application Publication
(10) Pub. No.: US 2008/0098133 A1
(43) Pub. Date: Apr. 24, 2008

(54) Bi-Directional Wired Interface

(76) Inventors: Tamir Shaanan, Herzlia (IL); Lev Freilicher, Netanya, IL (US)

Correspondence Address: JOHN ALEXANDER GALBREATH, 2516 CHESTNUT WOODS CT, REISTERSTOWN, MD, 21136, US

(21) Appl. No.: 11/573,306

(22) PCT Filed: Aug. 10, 2005
(86) PCT No.: PCT/IL05/00862

§ 371 Date: Feb. 6, 2007

Related U.S. Application Data
(60) Provisional application No. 60/641,671, filed on Jan. 6, 2005.

(51) Int. Cl. G06F 13/14

(52) U.S. Cl. 710/30

(57) ABSTRACT

A wired interface for communicating between a first part and a second part of a device including a line for controlling activation of the second part of the device by a signal from the first part of the device, two lines for transfer of data from the first part of the device to the second part of the device, two lines for transfer of data from the second part of the device to the first part of the device, two lines for the transfer of an indication signal from the second part of the device to the first part of the device regarding the validity of the data transferred by two lines from the second part of the device, and five lines for transferring control signals between the two parts.

### RELATED APPLICATIONS

The present application claims priority from U.S. provisional application 60/641,671 filed on Jan. 6, 2005, the disclosure of which is incorporated herein by reference.

### FIELD OF THE INVENTION

The present invention relates generally to a bidirectional wired interface for connecting between two parts of an electronic device.

### BACKGROUND OF THE INVENTION

Many electronic devices are physically split into two or more parts as a result of human interface considerations, an optimal position for each part within the electronic device they are embedded, or other reasons. The separate parts need to interface to each other and exchange information. An example of such a device is a personal computer, which comprises a central processing unit, a display, input parts (e.g. mouse, keyboard) and other output parts (e.g. a printer). Each of the parts includes electronic chips and/or circuits used to carry out the device's functionality. Typically, a bidirectional wired interface is defined for connecting between different parts of the device to enable any two parts that conform to the interface to communicate among themselves, for example a central processing electronic engine and its related peripherals. Some common interfaces are the parallel printing interface, the PCI interface and various serial interfaces like, the USB interface, the I²C interface and the Ethernet interface.

Some interfaces use a minimal set of lines (that transfer signals) for exchanging information between the device parts, while others use a larger set of lines. Generally, a smaller number of lines reduce the cost and complexity of the physical interface. However, too few lines can result in a limited bandwidth for information exchange, and/or may limit the functionality that can be implemented using the interface (e.g. reduced ability of one part to control the other part and vice versa). Additionally, fewer lines sometimes require more complex processing on both sides of the connection, for example a connection with only a transmit line, a receive line and a ground line requires that the device parts on both sides analyze the content of the transmissions to respond to control signals embedded within the serial based transmissions. Additionally, the response time for handling such control signals is limited by the required extent of analysis of the transmitted content, as well as the processing power existing within the device.

Typically, the addition of lines can improve the response rate between the device parts and can increase transmission speed (e.g. adding a synchronization line, various companion control lines, or parallel transmission data lines).

### SUMMARY OF THE INVENTION

An aspect of an embodiment of the invention relates to a bidirectional wired interface between a first part of a device and a second part of the device for controlling transmission and reception of data between the two parts.

In an exemplary embodiment of the invention, the interface is implemented in a device wherein the first part of the device receives an analog or digital signal from a transmitter application source, processes it and transfers it via the interface to the second part of the device for transmission out of the device on a wire, or as a wireless (e.g. radio frequency (RF) or optical) signal. In another exemplary embodiment of the invention, the interface is implemented in a device wherein the second part of the device receives a wired signal or a wireless (e.g. RF or optical) signal, processes it and transfers it via the interface to the first part of the device to deliver it after further processing as a digital or analog signal to a receiver application sink.

In an exemplary embodiment of the invention, the interface comprises two lines for transmission of a data signal from the first part to the second part, two lines for reception of a data signal by the first part from the second part, two lines for transmission of a validation indication signal, which accompanies the data signal from the second part to the first part, and indicates if the data transferred is valid data. Additionally, the interface comprises six lines for transferring control signals between the two parts of the device.

In an exemplary embodiment of the invention, one of the control lines comprises a receiver disable line, which allows the first part to turn off the reception of data by the second part from external sources. Optionally, the first part turns off the reception of data by the second part when it transfers data to the second part to transmit out of the device.

In an exemplary embodiment of the invention, four of the six control lines transfer control signals from the first part to the second part, and two of the six control lines transfer control signals from the second part to the first part.

In an exemplary embodiment of the invention, one of the control lines indicates to the first part that the second part is receiving a communication signal with adequate power or signal strength. Optionally, one of the control lines indicates to the first part that the content of the data signal from the second part is the initial part of an incoming communication signal.

In an exemplary embodiment of the invention, one of the control lines notifies the second part by the first part that initial acceptance of the received incoming frame of data was accomplished through synchronization on its preamble sequence, and the second part should shut off its preamble sequence detector, so as not to interfere with further steady state data receiving at this stage.

In an exemplary embodiment of the invention, one of the control lines notifies the second part by the first part that it has received indication of the end of the reception of a communication frame.

In an exemplary embodiment of the invention, one of the control lines notifies the second part by the first part that it should emit a signal between the transmission of communication frames, wherein the signal is a function of the data transmitted in the communication frame.

In an exemplary embodiment of the invention, two lines are used for the transfer of each of the data and validation indication signals over the interface from the second part to the first part in order to increase reliability and integrity of the transferred signals over these lines. Optionally, when transferring information (data or validation indication signals) using two lines, the signal is transferred in one line as a positive representation and in the other line as its opposite negative representation. At the receiving part the signals are subtracted (or negatively combined) to enhance the capability of the receiver to reconstruct the original data signal sent. This is commonly termed as differential signaling and allows for filtering out common mode noise sources that couple onto the lines in a similar fashion. Alternatively, other transmission methods are used for the transfer of information using two physical lines.

In an exemplary embodiment of the invention, the information from the validation indication signals on the two lines is used to validate and/or amend the data received by the first part that was transmitted from the second part. Optionally, pre-defined rules are used take into account the relative timing relationships between the data and validation indication signals for the benefit of filtering noise that has manifested itself as data on the data signal.

In an exemplary embodiment of the invention, the control lines of the interface allow for a full handshake protocol between the first part and the second part of the device.

### BRIEF DESCRIPTION OF THE DRAWINGS

The present invention will be understood and appreciated more fully from the following detailed description taken in conjunction with the drawings. Identical structures, elements or parts, which appear in more than one figure, are generally labeled with a same or similar number in all the figures in which they appear, wherein:

FIG. 1 is a schematic illustration of a wireless communication system comprising multiple wireless communication nodes, according to an exemplary embodiment of the invention;

FIG. 2 is a schematic block diagram of the components of a wireless communication node, according to an exemplary embodiment of the invention;

FIG. 3 is a schematic illustration of the structure of a sample communication signal, according to an exemplary embodiment of the invention;

FIG. 4 is a schematic block diagram of the structure of a receiver circuit within an analog-wireless sub system of a communication node, according to an exemplary embodiment of the invention;

FIG. 5 is a timing diagram of a set of interface signals, according to an exemplary embodiment of the invention;

FIG. 6 is a timing diagram of a set of interface signals without an end of frame pulse, according to an exemplary embodiment of the invention; and

FIG. 7 is a timing diagram of a set of interface signals in local transmission mode, according to an exemplary embodiment of the invention.

### DETAILED DESCRIPTION

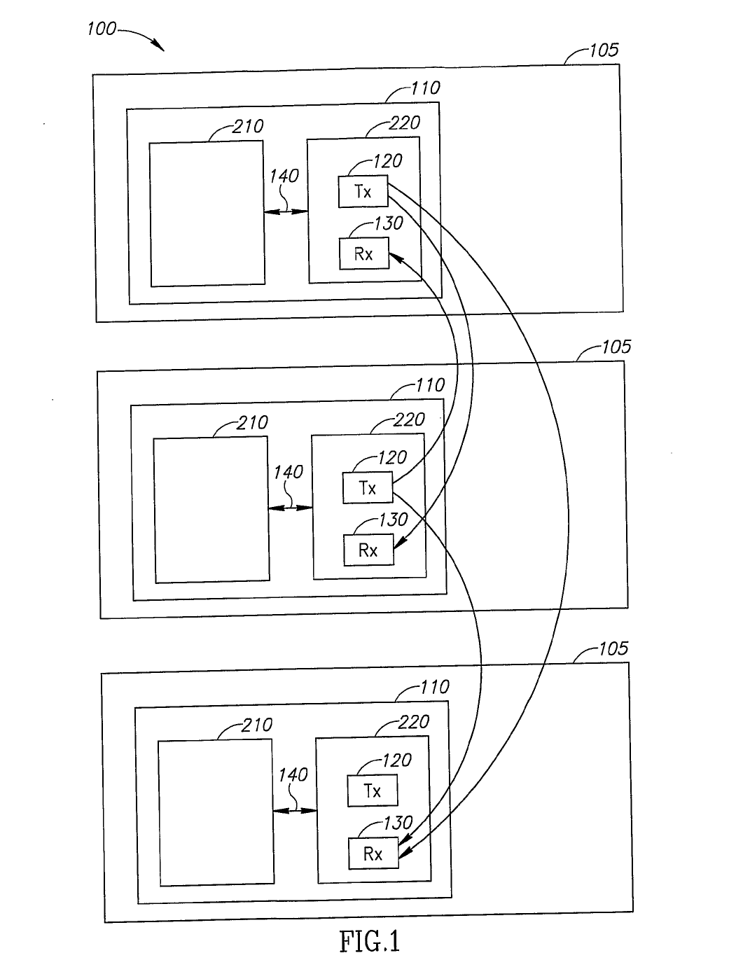

FIG. 1 is a schematic illustration of a wireless communication system 100 comprising multiple wireless communication nodes 110, according to an exemplary embodiment of the invention. In an exemplary embodiment of the invention, a device 105 (e.g. a plasma/LCD TV, amplifier, power speaker, toy, computer, medical device, vehicle accessory) that produces data incorporates wireless communication node 110 (termed as the “node” from hereon) to implement a wireless network or other topology of a wireless communication system with other devices 105 (e.g. wireless speakers for the plasma TV). Optionally, node 110 accepts data from device 105, performs optional processing of the data, for example amplification of the signal carrying the data, and transmits the data to other nodes.

In an exemplary embodiment of the invention, node 110 is embedded in an encasement of device 105. Alternatively, node 110 connects to device 105 externally using a standard interface, for example USB, RJ45, PCMCIA, RS232. In some embodiments of the invention, node 110 connects to device 105 using an interface defined by the manufacturer of device 105.

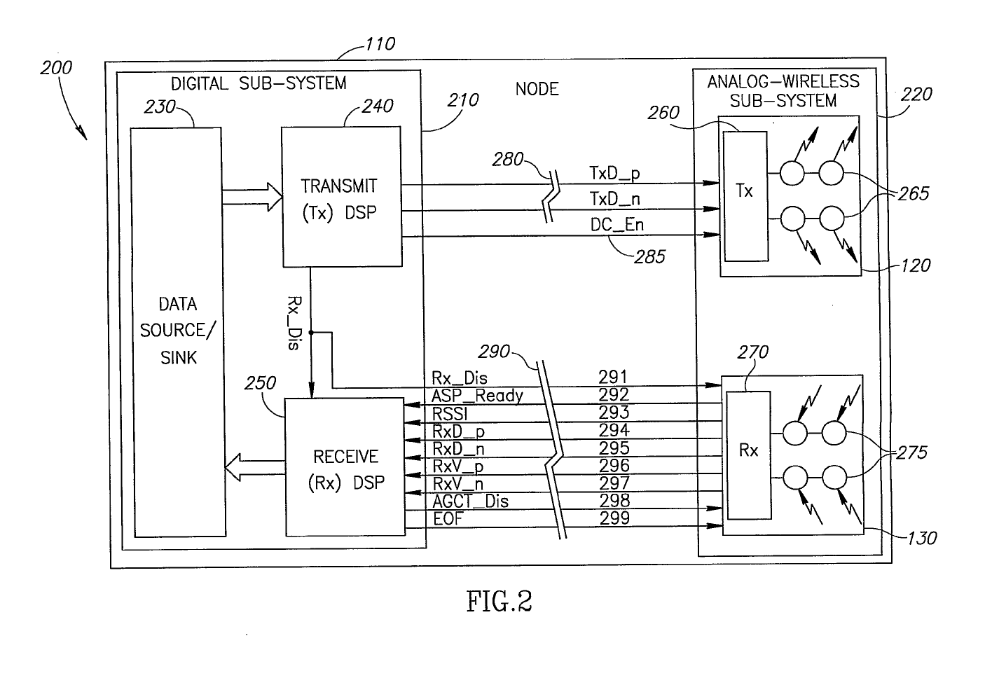

In an exemplary embodiment of the invention, node 110 is installed as part of device 105, to provide communication between multiple devices 105. In some embodiments of the invention, node 110 is built from two parts (210, 220), as described below in detail with regard to FIG. 2. Optionally, one part (210) accepts the data from the data source of device 105 for processing, and one part (220) deals with communication of the data to other nodes 110. In an exemplary embodiment of the invention, a unique interface 140 is used for interfacing between the two parts (210, 220) to allow for diversity and disparity of each part independent of the other, while reserving a common interoperable interface between them.

In an exemplary embodiment of the invention, both parts (210, 220) are positioned inside a common encasement. Alternatively, the part (210) that accepts data from the data source is embedded internal to device 105, for example inside an encasement of the device, while the part (220) that deals with communication with other nodes 110 is attached to the exterior of device 105, or is placed in a separate encasement outside of device 105. In an exemplary embodiment of the invention, a cable is used to attach between the two parts (210, 220) of node 110.

In an exemplary embodiment of the invention, node 110 comprises a transmitter 120 and a receiver 130. Optionally, node 110 implements wireless communication to other nodes 110, using a single communication channel to simplify the implementation of nodes 110. The single communication channel allows only one transmitter 120 to transmit at a time. In some embodiments of the invention, transmitter 120 may transmit using radio frequency (RF) transmissions, wherein all the nodes transmit at a single frequency. Alternatively, transmitter 120 may transmit using radio frequency (RF) transmissions, wherein all the nodes can transmit at multiple frequencies. Alternatively, transmitter 120 may transmit using infrared (IR) transmissions, wherein all the nodes use an infrared transmitter that transmits at the same wavelength.

Optionally, a communication protocol is used by nodes 110 in order to allow multiple nodes to share the single communication channel, effectively providing simplex, half duplex or virtual full duplex communication between nodes 110. In some embodiments of the invention, the communication protocol can be of a deterministic nature, for example a time division multiplexing (TDM) or Token Ring scheme. Alternatively, the communication protocol can be of a statistical nature for example as used in the Ethernet protocol (e.g. CSMA-CD or carrier sense, multiple access, collision detection) or a variation of these protocols. In some embodiments of the invention, all nodes 110 are active in transmitting data to each other. Alternatively, one node is active in transmitting data to the other nodes, which only receive data or only transmit back acknowledgments in response to the transmitted data.

In an exemplary embodiment of the invention, node 110 disables its receiver 130 while transmitting, to prevent it from receiving its own transmissions. Alternatively, node 110 may discard any transmissions received while transmitting.

FIG. 2 is a schematic block diagram 200 of the components of wireless communication node 110, according to an exemplary embodiment of the invention. In an exemplary embodiment of the invention, node 110 comprises a digital sub system 210 and an analog-wireless sub system 220. Optionally, digital sub system 210 interfaces between device 105 (e.g. computer, television, Internet modem) and node 110. Optionally, analog-wireless sub system 220 interfaces between node 110 and other nodes 110. In an exemplary embodiment of the invention, digital sub system 210 handles reception of a digital data signal from the device, for example an audio signal, a video signal and/or other signals. Optionally, digital sub system 210 enables processing of the signal, for example converting the signal format, encoding the signal, encrypting the signal, performing manipulations on the content of the signal and other processes.

In an exemplary embodiment of the invention, digital sub system 210 transmits the processed signal via a wired data line 280 to analog-wireless sub system 220 for wireless transmission to other nodes 110. Optionally, wired data line 280 comprises a pair of wires, for example a twisted pair, to transfer the digital data, for example in the form of a low voltage digital signal (LVDS) from digital sub system 210 to analog-wireless sub system 220. It is known in the art that a low voltage digital signal is optimally transferred using a positive line and a negative line in order to overcome common mode noise signals. The receiver of the low voltage digital signal subtracts the negative signal from the positive signal in order to filter out common mode noise signals and reach a signal with large amplitude for restoring the originally transmitted signal.

In some embodiments of the invention, digital sub system 210 comprises a data source sink (DSS) 230 for accepting, buffering and/or manipulating the signal. Optionally the DSS may include analog to digital conversion (ADC) and digital to analog conversion (DAC) circuits at its front end. Optionally, DSS 230 passes on the signal to a transmit data signal processor (TDSP) 240 for framing, scrambling, encrypting, encoding, and/or modulating of the signal before transferring it to analog-wireless sub system 220 for wireless transmission to other nodes. In an exemplary embodiment of the invention, a receive data signal processor (RDSP) 250, receives signals from analog-wireless sub system 220 and demodulates, decodes, decrypts, de-scrambles, and/or de-frames the signal before delivering the signal to DSS 230 for transfer to the device with which it interfaces.

In an exemplary embodiment of the invention, analog-wireless sub system 220 comprises transmitter 120 and receiver 130. Optionally, transmitter 120 accepts for transmission a data signal from TDSP 240 over data line 280. In an exemplary embodiment of the invention, transmitter 120 comprises a transmission circuit 260 that provides analog signal amplification (e.g. amplifying the transmitted signal before wireless transmission over the air medium), drive circuitry and digital logic for local digital processing and control (e.g. to prevent transmitter 120 from getting stuck in a continuous transmission situation). In an exemplary embodiment of the invention, transmitter 120 also comprises wireless transmitters 265, which are fed by transmission circuit 260 and wirelessly transmit a data signal over the air medium for reception by other nodes 110. In some embodiments of the invention, wireless transmitters 265 are RF emitters, antennas or other type of radio frequency transmitters that transmit radio frequency signals, for example of 900 Mhz, 2.4 Mhz, 5 Ghz, 5.8 Ghz and/or other frequencies. Alternatively or additionally, wireless transmitters 265 are optical emitters, for example Light Emitting Diodes (LED), Laser Diodes (LD) or Lasers, which transmit direct infrared or diffused infrared signals.

In an exemplary embodiment of the invention, TDSP 240 transmits a control signal DC_En 285 to transmitter 120 directing transmission circuit 260 to output a constant level voltage/current signal in between communication frames, which is the average of the transmitted data signal. This provides for a constant average DC level envelope signal for the overall communication signal. Low frequency interferences from node 110 are thus eliminated to devices that might be harmed from such noise sources (e.g. remote control receivers and the like).

In an exemplary embodiment of the invention, receiver 130 comprises a receiver circuit 270, and wireless receivers 275. Optionally, wireless receivers 275 accept RF transmissions and/or optical transmissions matching the transmissions of wireless transmitters 265, and provide them to receiver circuit 270. In an exemplary embodiment of the invention, receiver circuit 270 processes the received signal, for example providing analog signal processing such as:
1. Low noise pre-amplification for strengthening the signal;
2. Automatic gain control (AGC) to provide for constant amplification independent of receiver 130's range from other nodes;
3. Analog signal filtering to reduce channel noise and interferences; and
4. Analog decision circuits that provide for adaptive thresholding of signal levels.

Optionally, other processing may be provided by receiver circuit 270, for example implementing basic digital logic functions on the received signal data before they are transferred for further processing to the receive data signal processor (RDSP) 250.

In an exemplary embodiment of the invention, in the reverse direction of line 280, analog-wireless sub system 220 receives transmissions from other nodes 110 by receiver 130 and passes them on via a wired interface 290 to digital sub system 210. Optionally, wired interface 290 comprises control lines in addition to data lines and effectively controls transmission and reception of data by node 110.

In an exemplary embodiment of the invention, wired interface 290 provides a signal for enabling and disabling reception of data by receiver 130.

In an exemplary embodiment of the invention, wired interface 290 comprises five groups of lines:
1. A receiver disable line 291, which serves as an activation/deactivation switch for data reception by node 110.
2. Two lines 294, 295 for transfer of a low voltage digital signal for data from receiver circuit 270 to RDSP 250.
3. Two lines 296, 297 for transfer of a low voltage digital signal indicating if the data transferred on lines 294, 295 is valid.
4. Two lines 292, 293 with control indications from receiver circuit 270 to RDSP 250.
5. Two lines 298, 299 with control indications from RDSP 250 to receiver circuit 270.

In the following explanations the function of these five groups shall be described in more detail. Optionally, the combination of line 280, line 285 and wired interface 290 form the unique interface 140 for interfacing between the two parts (210, 220) of node 110.

In an exemplary embodiment of the invention, line 280, line 285 and wired interface 290 are created through electronic connections on a printed circuit board (PCB), or by soldering wires between analog-wireless sub system 220 and digital sub system 210. Alternatively, a connector is placed on each side of sub systems 210 and 220, and a cable with matching connectors is used to form the connections.

In order to understand the function of some of the lines described above, the structure of a communication signal and its handling by receiver circuit 270 and RDSP 250 will be described.

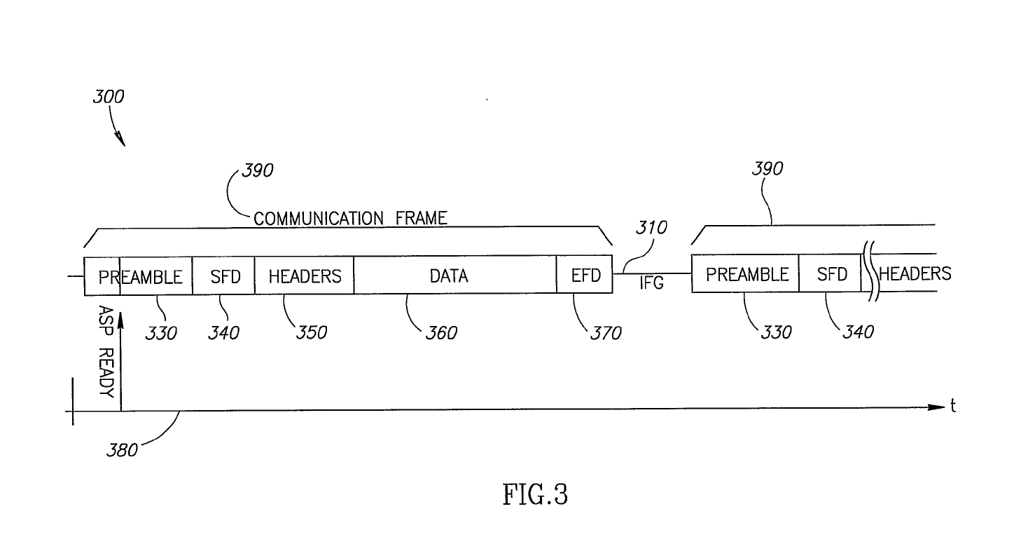

FIG. 3 is a schematic illustration of the structure of an exemplary communication signal 300, according to an exemplary embodiment of the invention. In an exemplary embodiment of the invention, communication signal 300 comprises multiple communication frames 390 of optionally varying length. Communication frames 390 are followed by a pause in communication referred to as an inter frame gap (IFG) 310, which separates between communication frames 390 and is also optionally of varying length. In an exemplary embodiment of the invention, inter frame gap 310 is of a constant size during a communication session and of indefinite length after the end of the session.

In an exemplary embodiment of the invention, communication frames 390 begin with a preamble sequence 330. Optionally, preamble sequence 330 gives indication to receiver circuit 270 that a communication frame 390 is being received. Additionally, preamble sequence 330 enables receiver circuit 270 to synchronize onto incoming communication signal 300, for example using a phase lock loop (PLL) circuit. Additionally, preamble sequence 330 allows receiver circuit 270 to adjust the amplification level required according to the strength of the incoming signal using an automatic gain control (AGC) circuit, before the communication frame's data is received and processed. In an exemplary embodiment of the invention, control line 292 (referred to as analog signal processor (ASP) ready (ASP_Ready), gives indication to RDSP 250 that receiver circuit 270 has reached its optimal amplification level and that it can further process the incoming communication signal. Timeline 380 in FIG. 3 shows schematically the point at which the ASP_Ready signal is asserted active relative to communication frame 390.

In an exemplary embodiment of the invention, a start of frame delimiter (SFD) field 340 follows preamble sequence 330. The start of frame delimiter field 340 indicates that the preamble sequence 330 has terminated and the communication frame header/data is starting. Immediately after the start of frame delimiter (SFD) field 340 a header field 350 is supplied. Header field 350 typically includes information regarding the data, for example its size, type, source address, intended destination address and other control information that needs to be conveyed to the receiver of the message.

Following header field 350 comes data field 360 with parts of the actual data message that is being transmitted. In some embodiments of the invention, data field 360 has a fixed length to simplify handling of the transmissions by the receiver. Alternatively, data field 360 may have a varying length in order to ease constraints on the transmitter.

In an exemplary embodiment of the invention, communication frame 390 ends with an end of frame delimiter (EFD) 370 to signal the end of the communication frame. Optionally, end of frame delimiter (EFD) 370 is used to give indication to RDSP 250 to reset receiver circuit 270 and wait for the next communication frame 390.

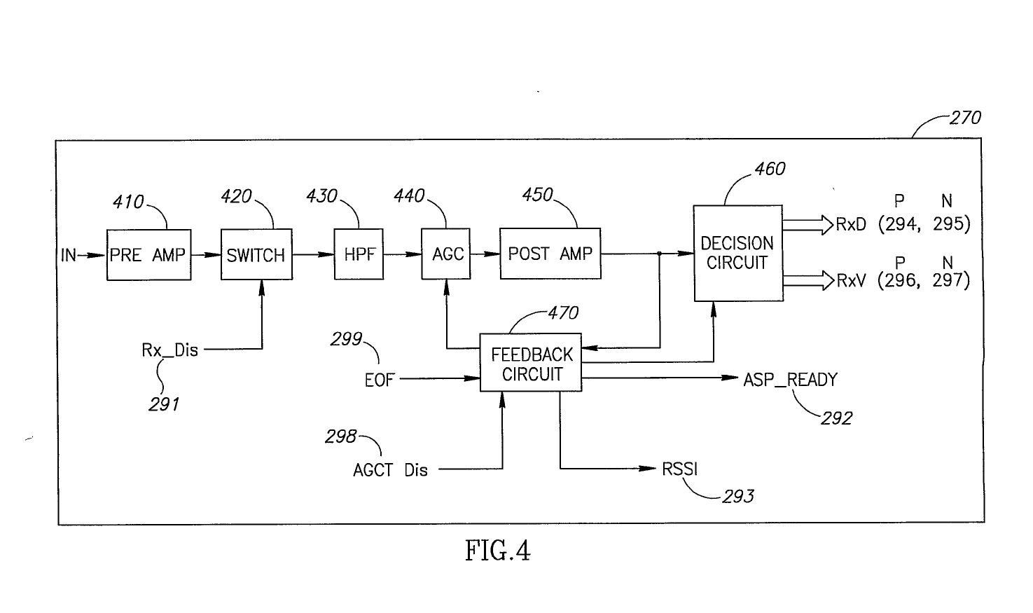

FIG. 4 is a schematic block diagram of the structure of receiver circuit 270, according to an exemplary embodiment of the invention. In an exemplary embodiment of the invention, wireless receivers 275 accept a communication signal 300 from another node 110. Optionally, communication signal 300 is transferred to receiver circuit 270 into a pre-amplifier 410, which serves as a low noise amplifier (LNA) to amplify the incoming (possibly low power) signal while reducing manifested noise.

In an exemplary embodiment of the invention, the data is transferred to a switch 420, which either transfers on the data or blocks its reception to the rest of receiver circuit 270 according to instructions from TDSP 240. In an exemplary embodiment of the invention, TDSP 240 gives instruction on line 291 (receiver disable (Rx_Dis)) to RDSP 250 and switch 420 of receiver circuit 270 to block reception of data. Optionally, when node 110 transmits over the wireless medium, it is interested in disabling self-reception of data in its receiver 130 in order to be ready at high gain to receive transmissions from other nodes 110 and prevent itself from saturating wireless receivers 275 by its own transmissions.

In an exemplary embodiment of the invention, a high pass filter (HPF) 430 resides after switch 420. HPF 430 filters out low frequency noise that typically results from low frequency operating devices, for example remote controllers, various types of lamps and other devices.

In an exemplary embodiment of the invention, if switch 420 does not block reception of data, the data is passed on to an automatic gain control (AGC) circuit 440 followed by a post amplifier (POST AMP) circuit 450. Automatic gain control circuit 440 automatically sets the amplification level required for amplifying the data signal, further to the level set by pre amp 410, according to the distance of node 110 from the transmitting node. Optionally, automatic gain control circuit 440, together with post amplifier circuit 450, amplify the data signal to the required level of amplification for being worthy of transfer to RDSP 250. In an exemplary embodiment of the invention, a decision circuit 460 receives the amplified data signal and outputs the data signal (294, 295) and an accompanying valid indication signal (296, 297), which gives indication if the data signal is valid or not based on the shape of the resulting amplified data signal after operation of HPF 430 on the incoming signal. Optionally, valid data will be processed by RDSP 250, however invalid data will be ignored, discarded or set to ‘zero’. The handling of invalid data depends on the overall transmission protocol. In some protocols node 110 will ask for retransmission of invalid data from the transmitting node. Alternatively, the transmissions may comprise inherent data correction means, for example through forward error correction (FEC) redundancy information (e.g. parity bits), and related algorithms, which may not require retransmission of the invalid data, but rather its “on the fly” correction at RDSP 250.

In an exemplary embodiment of the invention, the data signal is transmitted as a low voltage digital signal (LVDS) to RDSP 250. Optionally, line 294 provides the positive representation and line 295 provides the negative representation of the low voltage digital signal. In an exemplary embodiment of the invention, the validation indication signal is also transmitted as a low voltage digital signal to RDSP 250 wherein line 296 provides the positive representation and line 297 provides the negative representation.

In an exemplary embodiment of the invention, a feedback circuit 470 is connected between post amplifier circuit 450 and automatic gain control circuit 440 to provide feedback of DC and gain parameters to enable the automatic amplification of the data signal to its required level around a correct DC level signal. Optionally, feedback circuit 470 provides two control signals to RDSP 250 and receives two control signals from RDSP 250. In an exemplary embodiment of the invention, feedback circuit 470 provides a received signal strength indicator (RSSI) on line 293, which gives indication to RDSP 250 that a communication signal 300 of adequate signal strength and power is in initial transition through receiver circuit 270.

Additionally, feedback circuit 470 provides an analog signal processor ready (ASP_Ready) indication on line 292. Optionally, ASP_Ready signals RDSP 250 that automatic gain control circuit 440 has reached its required amplification level responsive to detection of a valid preamble sequence 330 and RDSP 250 can synchronize on the received signal and accept it for further processing from thereon.

In an exemplary embodiment of the invention, RDSP 250 provides an automatic gain control disable signal (AGCT_Dis) on line 298 to feedback circuit 470. Optionally, automatic gain control disable signal (AGCT_Dis) allows RDSP 250 to shut down preamble sequence detection in feedback circuit 470 in order to return the ASP_Ready signal to its inactive state, and transition to steady state data acceptance mode while a communication signal 300 is arriving over the medium.

In an exemplary embodiment of the invention, when RDSP 250 receives the end of frame delimiter (EFD) 370 it gives an end of frame (EOF) signal to feedback circuit 470 on line 299. Optionally, EOF resets automatic gain control circuit 440 and feedback circuit 470 to prepare for the next communication frame 390 or communication signal 300.

In an exemplary embodiment of the invention, after reception of a communication frame, or its respective detection by nodes 110 that are not its intended recipient, all nodes 110 wait at least the time of inter frame gap (IFG) 310 before attempting to transmit again on the medium. This allows receiver circuit 270 to be reset and prepare itself for the next transmission.

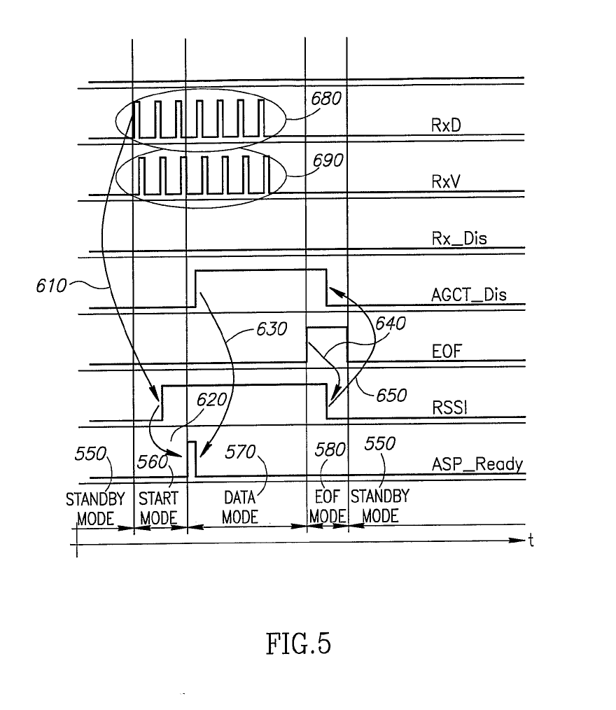

FIG. 5 is a timing diagram illustrating the signals as a function of time on wired interface 290, according to an exemplary embodiment of the invention.

In an exemplary embodiment of the invention, the receiving system of node 110, which comprises receiver circuit 270, wireless receivers 275 and RDSP 250, is initially in a standby mode 550. Optionally, a communication frame 390 arrives at receiver circuit 270. Communication frame 390 begins with a preamble sequence that creates signal 680 on lines 294, 295 (data signal) and signal 690 on lines 296, 297 (validation indication signal) of wired interface 290. Arrival of signals 680 and 690 stimulate the process of receiving data, causing the receiving system of node 110 to transit into a start mode 560. The signals on lines 294, 295, 296 and 297 do not represent actual data at this stage since they originate from preamble sequence 330. Optionally, at this stage RDSP 250 begins hardware electronic synchronization on these signals, but waits for the ASP_Ready signal from line 292 to signal it to start accepting the content of the data signal and validation indication signal (lines 294, 295 and 296, 297 respectively). Following initial acceptance of communication frame 390, feedback circuit 470 asserts 610 line 293 (RSSI) active to notify RDSP 250 that a communication signal 300 with adequate signal and power strength is being received (based on the preamble sequence) and not random noise. RSSI stays asserted active until the end of communication frame 390 when signal power from the transmitting node vanishes in the medium. Following the indication on line 293 (RSSI), and the continued arrival of data, line 292 (ASP_Ready) is asserted active 620 to indicate that receiver circuit 270 has synchronized on the data of communication frame 390. Receiver 130 of node 110 changes to data mode 570, wherein it starts to analyze the data from lines 294, 295, while taking into account the validation indication signal on lines 296 and 297. Optionally, after accepting the ASP_Ready signal on line 292 and registering that receiver 270 is ready, RDSP 250 asserts the automatic gain control disable (AGCT_Dis) signal active on line 298, which shuts down 630 the ASP_Ready signal, prevents it from pulsating, and indicates that ASP_Ready has finished its role at this stage of communication frame analysis. Optionally, the AGCT_Dis signal is kept asserted active until the end of communication frame 390. After raising AGCT_Dis, RDSP 250 remains locked on accepting data from communication frame 390 until an end of frame condition occurs.

In some embodiments of the invention, RDSP 250 identifies an end of frame delimiter (EFD) 370 from the incoming communication frame. Optionally, RDSP 250 will give an end of frame (EOF) pulse on line 299 to notify receiver circuit 270 that the communication frame has ended and it must reset its AGC and feedback circuits.

In an exemplary embodiment of the invention, the receiving system of node 110 will transit to end of frame mode 580 and will de-assert 640 the RSSI signal on line 293. When the RSSI line 293 transits to the inactive state, RDSP 250 de-asserts 650 AGCT_Dis on line 298. Optionally, when AGCT_Dis transits to the inactive state, preamble sequence detection in feedback circuit 470 is ready again to detect a new incoming preamble sequence of the next communication frame. At this stage, AGC circuit 440 transits to its maximum amplification state in order to be ready to receive the next incoming transmission of a communication signal. After the EOF pulse is de-asserted on line 299, the receiving system of node 110 goes back to standby mode 550 for the next arrival of a communication frame 390 or communication session to be received.

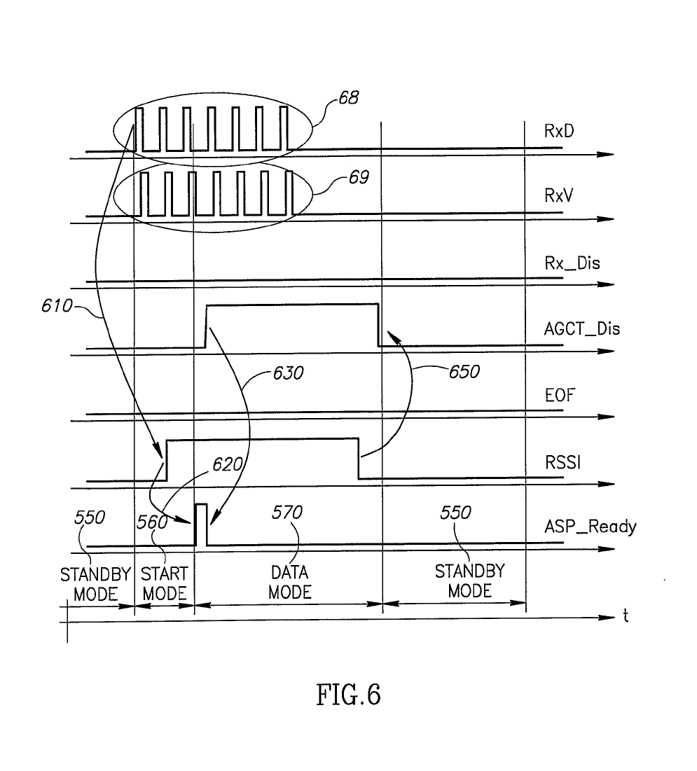

In some embodiments of the invention, the communication frame or session at the receiver 270 will end without arrival of an end of frame delimiter 370, for example if the transmitting node 110 stopped transmitting from some reason. FIG. 6 is an alternative timing diagram for the signals of wired interface 290 in a case without an end of frame pulse, according to an exemplary embodiment of the invention. Optionally, when receiver circuit 270 identifies that communication frame 390 has stopped arriving it de-asserts the RSSI signal on line 293. When RSSI line 293 transits to the inactive state, RDSP 250 de-asserts 650 AGCT_Dis on line 298. Preamble sequence detection in feedback circuit 470 is ready again to detect a new incoming preamble sequence of the next communication frame. AGC circuit 440 transits to its maximum amplification state and the receiving system of node 110 goes back to standby mode 550 for the next communication frame 390 or communication session to be received.

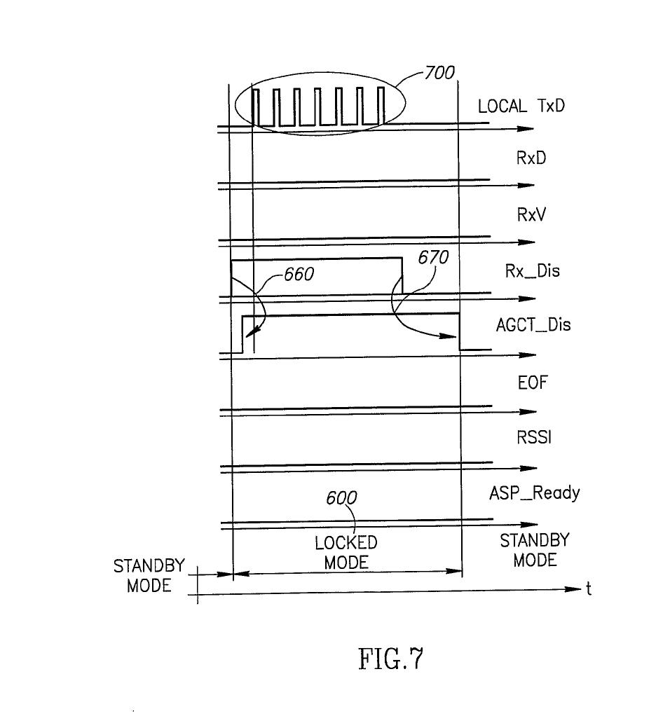

FIG. 7 is a timing diagram for the signals of wired interface 290 in local transmission mode, according to an exemplary embodiment of the invention. In an exemplary embodiment of the invention, when node 110 wants to transmit over the wireless medium to other nodes 110, it is required to block local reception of the signal being transmitted by its receiver circuit 270. In order to block local reception, TDSP 240 asserts receive disable (Rx_Dis), line 291 active. In response, Switch 420 of receiving circuit 270 blocks the transfer of analog signals from Pre AMP 410 to AGC 440, and the receiving system of node 110 transits to a locked mode 600. Additionally, RDSP 250 asserts 660 AGCT_Dis active to ensure that preamble sequence detection in feedback circuit 470 is inactive. Further additionally, AGC 440 remains idle and at its maximum amplification state. Additionally, AGCT_Dis ensures that no other signals are asserted active on wired interface 290 other than Rx_Dis and AGCT_Dis. In this state a transmission 700 can be sent from local node 110 to other remote nodes 110. When transmission 700 ends, Rx_Dis is de-asserted on line 291. As a result line 298 (AGCT_Dis) is also de-asserted 670 by RDSP 250 and the receiving system of node 110 transits back to standby mode. When in standby mode, node 110 can receive transmissions or start transmitting to other nodes 110 according to the communication protocol implemented and the current communication needs of the node.

In an exemplary embodiment of the invention, digital sub system 210, and analog-wireless sub system 220 are each optionally implemented by a single integrated chip. Alternatively, digital sub system 210 and analog-wireless sub system 220 are each implemented by a discrete electronic circuit including various integrated chips, for example receiver circuit 270 may comprise a single integrated chip and other parts of the circuit comprise discrete form components.

In some embodiments of the invention, the lines on unique interface 140 use standard voltage values, which are commonly used in electronic circuits, for example 12V, 5V, 3.3V, 1.8V or higher or lower voltage values. Optionally, lines 280 and 285 may use different voltage values than used on wired interface 290. In some embodiments of the invention, some lines on unique wired interface 140 may use one voltage value, like low voltage digital signaling (LVDS), and other lines may use a different voltage value.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

Section headings are provided for assistance in navigation and should not be considered as necessarily limiting the contents of the section.

It will be appreciated by persons skilled in the art that the present invention is not limited to what has been particularly shown and described hereinabove. Rather the scope of the present invention is defined only by the claims, which follow.

1. A wired interface for communicating between a first part and a second part of a device comprising:
a line for controlling activation and deactivation of the second part of the device by a signal from the first part of the device;
two lines for transfer of data from the first part of the device to the second part of the device;
two lines for transfer of data from the second part of the device to the first part of the device;
two lines for transfer of an indication from the second part of the device to the first part of the device regarding the validity of the data transferred by the two lines from the second part of the device; and
five lines for transferring control signals between the two parts.

2. A wired interface according to claim 1, wherein three of said five lines transfer control signals from the first part to the second part.

3. A wired interface according to claim 1, wherein two of said five lines transfer control signals from the second part to the first part.

4. A wired interface according to claim 1, wherein said first part is connected to a device to exchange data with it.

5. A wired interface according to claim 1, wherein said second part transmits and receives data wirelessly.

6. A wired interface according to claim 3, wherein one of the control lines asserts a signal active as long as the second part is receiving data with adequate signal strength from the wireless medium.

7. A wired interface according to claim 3, wherein one of the control lines asserts a signal active to the first part indicating that a valid communication frame is in transition and has been synchronized onto.

8. A wired interface according to claim 2, wherein one of the control lines gives indication to the second part that an end of data of a communication frame has been reached.

9. A wired interface according to claim 2, wherein one of the control lines gives indication to the second part that it should disable preamble sequence detection, as well as lock its current amplification status for further frame data receiving.

10. A wired interface according to claim 2, wherein one of the control lines gives indication to the second part to transmit a signal between transmission of communication frames; wherein said signal is a function of the data transmitted in the communication frame.

11. A wired interface according to claim 1, wherein said first part and said second part are connected by said wired interface in a common encasement.

12. A wired interface according to claim 1, wherein said first part and said second part are in separate encasements.

13. A wired interface according to claim 1, wherein the first part and the second part are connected by printed circuit wires on a common printed circuit board.

14. A wired interface according to claim 1, wherein the first part and the second part are connected by a cable.

15. A wired interface according to claim 1, wherein data transferred on two lines is transferred as a positive signal on one line and a negative signal on the other line; and the two signals are subtracted to produce a combined signal with inherent resistance to common mode noise.

16. A wired interface according to claim 1, wherein all the lines of said wired interface transmit signals using the same voltage.

17. A wired interface according to claim 1, wherein some of the lines of said wired interface transmit signals using a different voltage than the other lines.
